(19) United States
(12) Patent Application Publication
(10) Pub. No.: US 2020/0298139 A1
(43) Pub. Date: Sep. 24, 2020

(54) HYDRO DISTILLATION OF AROMATIC PLANT BASED COMPOUNDS

(71) Applicant: Stefan FITZER, Nevada City, CA (US)

(72) Inventor: Stefan FITZER, Nevada City, CA (US)

(21) Appl. No.: 16/818,049

(22) Filed: Mar. 13, 2020

Related U.S. Application Data
(60) Provisional application No. 62/819,831, filed on Mar. 18, 2019.

(51) Int. Cl. B01D 3/38; C11B 9/02; B01D 5/00

(52) U.S. Cl. CPC B01D 3/38; B01D 5/006; B01D 5/0027; C11B 9/027

(57) ABSTRACT

A water based distillation equipment includes a lower boiling vessel for containing plant material and water/steam, and having an open top portion; a heat source for heating the plant material within the lower boiling vessel; and a condenser mechanically connected to the lower boiling vessel so as to cover the open top portion of the lower boiling vessel; and a collection vessel connected to the distillation equipment. The inside walls of the condenser include gutters for collecting hydrolate and condensate within the distillation equipment, and the collection vessel is coupled to the gutters for receiving the collected condensate. The surface area of the condenser is at least about 1.5 times a surface area of the lower boiling vessel.

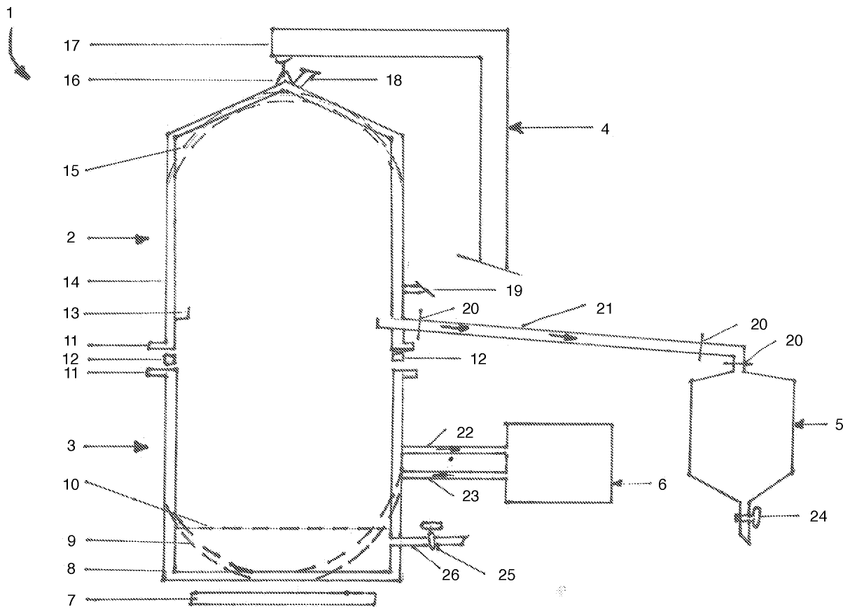

### CROSS REFERENCE TO RELATED APPLICATIONS

The present application claims the benefit from U.S. Provisional Application No. 62/819,831 filed Mar. 18, 2019, the content of which is hereby incorporated by reference into this application.

### TECHNICAL FIELD

The present disclosure relates to specific low pressure and temperature water based processing equipment to produce aromatic hydrosol and terpenes, including essential oils.

### BACKGROUND

The subject matter of the present disclosure solves several problematic designs and work flows in all commonly available extraction units for water based aromatic volatile extraction.

All common extraction equipment ‘forces’ the volatile molecules through small diameter tubing into a separate condenser, thus creating unnecessary pressures and movement of the most fragile and volatile molecules.

Cohobation is the process of steam condensing on the equipment walls and tubing before it gets trapped in the condenser and re-entering the plant material containing vessel. This creates less desirable results in aromatic distillations as the more fragile volatiles are heated again and again.

Separate tubing type condensers of various types (e.g., Liebig, Spiral, cold finger etc.) are difficult to clean as their small orifice ports aren't accessible by hand. The only way to clean them completely is to anneal them. This is especially important for plant materials like resins, where certain volatile components can be challenging to clean.

Common home and laboratory use equipment employs boiling vessels with small diameter openings, which increases the cohobation effect and makes it very difficult to load or discharge plant matter, thus increasing time and labor costs for cleaning.

### SUMMARY OF THE DISCLOSURE

The water based distillation equipment according to an exemplary embodiment includes:

a lower boiling vessel for containing plant material, the boiling vessel having an open top portion;

a heat source for heating the plant material within the lower boiling vessel; and

a condenser mechanically connected to the lower boiling vessel so as to cover the open top portion of the lower boiling vessel; and

a collection vessel connected to the distillation equipment. The inside walls of the condenser include gutters for collecting hydrolate and condensate within the distillation equipment, and the collection vessel is coupled to the gutters for receiving the collected condensate. The surface area of the condenser is at least about 1.5 times a surface area of the lower boiling vessel.

The subject matter of the present disclosure can be operated as a hydro- as well as a steam-distillation unit. It may be fabricated as small as a 1 gallon home use unit to large 1000 gallon stainless steel units with glass lined extraction chambers and an external steam/heat generator.

The present equipment differs from other equipment in that it has a unique large (minimum of 6″) diameter condenser opening that directly attaches to the vessel containing the plant matter, similar to a lid on a kitchen cooking pot. The diameter of the condenser opening relates to the overall capacity of the unit always matching the diameter of the boiling vessel.

This condenser is externally, or through jacketed design, cooled by recirculating cooling liquid to provide an even, low temperature environment for the condensation to occur. In one embodiment, this cooling circuit stays at or around 5 degrees centigrade for optimum condensation of the hydro steam.

The unique design and function of the collection gutter inside the condenser allows for the hydrolate to be collected in the external collection vessel. It therefore eliminates cohobation, and other re-entering of condensate into the heating vessel and plant material.

The present equipment design eliminates cleaning problems of other closed and narrow condensers commonly available thus making reliability, sterility and non-contaminated high quality aromatic volatiles possible.

The apparatus is coupled, but not dependent on a general spherical design of the entire distillation vessel and condenser.

Another benefit of the present equipment is the relatively low resistance the volatile steam encounters while emerging into the condenser. There are no small diameter pipes or orifices that the steam has to travel through in order to reach the condenser thus creating a superior quality aromatic distillate.

The present equipment is designed to operate at around atmospheric pressure relating to the location of operation, and temperatures associated with the specific uses described below.

The present equipment designed to have a condenser surface area of approximately 1.5 times the size of the boiling vessel surface area giving of steam.

The present disclosure covers processing equipment fabricated in all different types of materials that employ any of the above mentioned parameters and designs.

### BRIEF DESCRIPTION OF THE DRAWING

The FIGURE is a schematic view of the distillation equipment according to the disclosure.

### DESCRIPTION OF THE PREFERRED EMBODIMENTS

The FIGURE shows the structure of the distillation equipment 1 according to the present disclosure including the unique large diameter condenser 2 and the lower boiling vessel 3.

A crane 4 is shown in order to raise or lower the condenser 2 onto the boiling vessel 3. The distillation equipment 1 includes a collection vessel or separation funnel 5 in order to catch aromatic condensate, an optional external steam generator 6 for heating the boiling vessel 3 through a dual jacket or inject dry steam into steam distillation, and an optional direct heat source 7, such as, for example, an electric heating mantel or a gas burner.

The distillation equipment 1 has a single or optional dual jacket vessel 8, an optional kettle design for allowing more even heat and better boiling characteristics in hydro distillation, and an optional strainer grid 10 for holding plant material above the boiling water (wet steam distillation) or above stream injection (dry steam distillation).

The boiling vessel 3 and the condenser 2 are sealed together by, for example, flanges 11 and wing nuts, and a food grade seal 12 is used to seal the flange between the boiling vessel 3 and the condenser 2. As shown in the FIGURE, the condenser 2 includes a continuous slanted gutter 13 in order to catch the condensate running down the inside walls of the condenser 2 and directing the condensate to a gravity-fed outlet towards collection vessel 5. The distillation equipment 1 shown in the FIGURE includes single or dual jacket condenser walls 14 for flexible cooling methods and with an optional cylindrical-domed top for even efficient condensate flow towards the collection gutter 13. The optional round dome shape 15 also optimizes steam distribution and circulation in the condenser 2.

The FIGURE shows at the top of the distillation equipment 1 an adjustable and flexible joint 16 for optimized movement of the condenser 2 onto the boiling vessel 3 via the sturdy crane arm 17 of the crane 4.

The distillation equipment 1 includes an optional recirculating coolant outlet 18 and an optional recirculating coolant inlet 19, and optional quick disconnect clamps 20 for easy cleaning and transport. A condensate collection tube 21 is employed in order to direct collected condensate away from the condenser 2 into the collection vessel 5.

The optional external steam generator 6 includes a steam generator inlet 22 and a steam generator outlet 23.

The collection vessel 5 includes a stop cock 24 to separate water soluble from aromatic oil condensate, and an optional valve 25 can be used to open or close steam injection inlet 26 for dry steam distillation.

The operation of the distillation equipment 1 will now be described.

The distillation equipment 1 is charged for operation by water and plant material (hydro-distillation) in the boiling vessel 3 without the use of the removable strainer 10. For steam-distillation, the distillation equipment can be loaded with plant material on the strainer 10 and either an appropriate amount of water is provided below the strainer 10 (wet steam distillation), or the injection of steam (dry steam distillation) is provided through the steam injection inlet 26.

In a typical aromatic distillation process with the distillation equipment 1 shown in the FIGURE, the charge would then be heated slowly either by the direct heat source 7 or the optional steam generator 6 until the volatile aromatics are released from the plant material in the boiling vessel 3 and the steam rises into the condenser 2. The distillation equipment is designed to operate under normal atmospheric pressure and temperatures not to exceed the temperature of boiling water and water steam.

The distillation equipment 1 shown in the FIGURE is unique in the design of the condenser 2 in that the steam generated in the boiling vessel 3 passes into the condenser 2 without hindrance or steam being pushed through any tubes etc. The distillation equipment 1 then provides a cool (for example 5 Degrees Celsius) surface inside the condenser 2 by using the single wall or jacketed design 14 for the steam to efficiently condensate back to a liquid state. The ratio of the surface area of the inside condenser walls and the generated steam are of importance and are reflected in this invention design. The now condensed liquid then runs down the inside condenser walls and is then collected by the unique continuous slanted gutter 13 all around the condenser, which drains by gravity into the collection vessel 5 via the collection tube 21. Once the plant material has been extracted thoroughly, the heat source (either direct heat source 7 or the external steam generator 6) is turned off, and the process is complete.

The distillation equipment 1 also reduces cleaning and loading time by having no small diameter ports or openings. The connection flanges 11 of the condenser 2 and boiling vessel 3 are large diameter for ease of access, thus reducing labor costs significantly.

What is claimed is:

1. A water based distillation equipment comprising:
a lower boiling vessel for containing plant material and water/steam, said boiling vessel having an open top portion;
a heat source for heating the plant material within said lower boiling vessel; and
a condenser mechanically connected to said lower boiling vessel so as to cover the open top portion of said lower boiling vessel; and
a collection vessel connected to the distillation equipment;
wherein insides walls of said condenser include gutters for collecting hydrolate and condensate within the distillation equipment, said collection vessel is coupled to said gutters for receiving the collected condensate, and wherein a surface area of said condenser is at least about 1.5 times a surface area of said lower boiling vessel.

2. The distillation equipment according to claim 1, further including a collection tube connected to said gutters for directing collected condensate to said collection vessel.

3. The distillation equipment according to claim 1, wherein said condenser has a round dome shape at a top end thereof.

4. The distillation equipment according to claim 3, wherein said lower boiling vessel has a kettle shape at a bottom end thereof.

5. The distillation equipment according to claim 1, wherein said heat source is an external steam generator coupled to said lower boiling vessel.

6. The distillation equipment according to claim 1, wherein a diameter of said condenser is at least about 6 inches, and wherein a diameter of said lower boiling vessel matches the condenser diameter so as to cover and form the distillation equipment.

7. The distillation equipment according to claim 1, wherein walls of said condenser and said lower boiling vessel are of jacketed design.

8. The distillation equipment according to claim 1, further comprising a coolant inlet and a coolant outlet connected to walls of said distillation equipment for recirculating coolant.

9. The distillation equipment according to claim 1, further comprising a strainer grid located in said lower boiling vessel for containing plant material.

10. The distillation equipment according to claim 2, further comprising a disconnect clamp for disconnecting said collection tube from the distillation equipment.

11. The distillation equipment according to claim 1, wherein a size of the distillation equipment is between a 1 gallon unit and a 1,000 gallon unit.

12. The distillation equipment according to claim 11, wherein the distillation is made of stainless steel.

13. The distillation equipment according to claim 12, further comprising a joint coupled to a top outer portion of said condenser, and a crane including a crane arm connectable to said joint for moving said condenser onto said lower boiling vessel.

14. The distillation equipment according to claim 1, wherein said condenser and said lower boiling vessel have flanges for mechanically connecting together said condenser and said lower boiling vessel.

15. The distillation equipment according to claim 1, wherein said collection vessel includes a stop cock located at a bottom portion thereof.
